(19) United States
(12) Patent Application Publication
(10) Pub. No.: US 2006/0179993 A1
(43) Pub. Date: Aug. 17, 2006

(54) Espinosa product cutter

(76) Inventor: Robert Espinosa, Sanger, CA (US)

Correspondence Address: Robert Espinosa, P.O. Box 931, Sanger, CA, 93657, US

(21) Appl. No.: 11/056,841

(22) Filed: Feb. 11, 2005

(51) Int. Cl. B26D 1/00

(52) U.S. Cl. 83/651

(57) ABSTRACT

Piece of machinery that allows product of any width and any length to be cut into pieces of any size by running the product over a number of saw blades, and then through a second set of saw blades cutting the first pieces into smaller pieces, all with increased production, less staff, better appearance, less waste, and reduced chance of catastrophic worker injury.

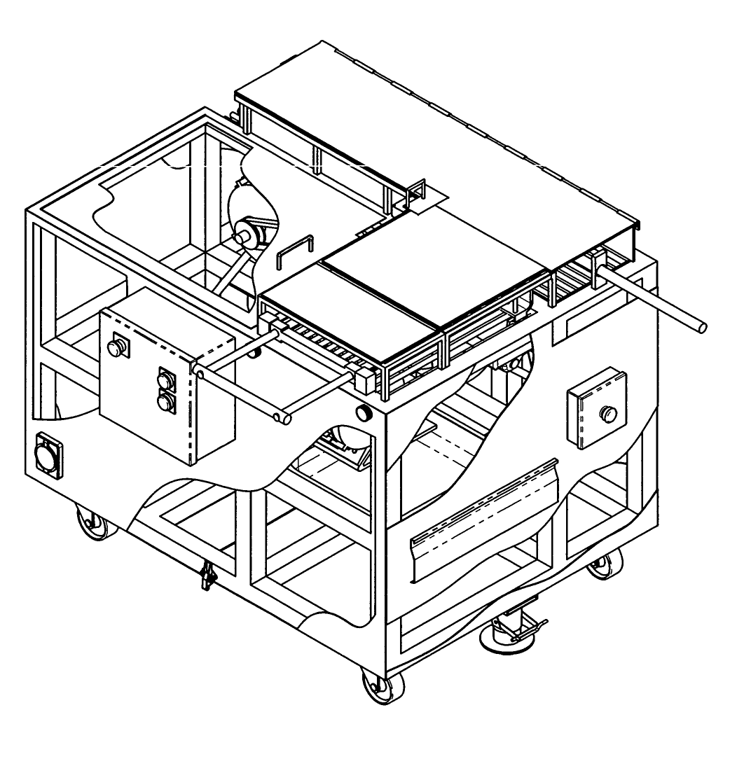

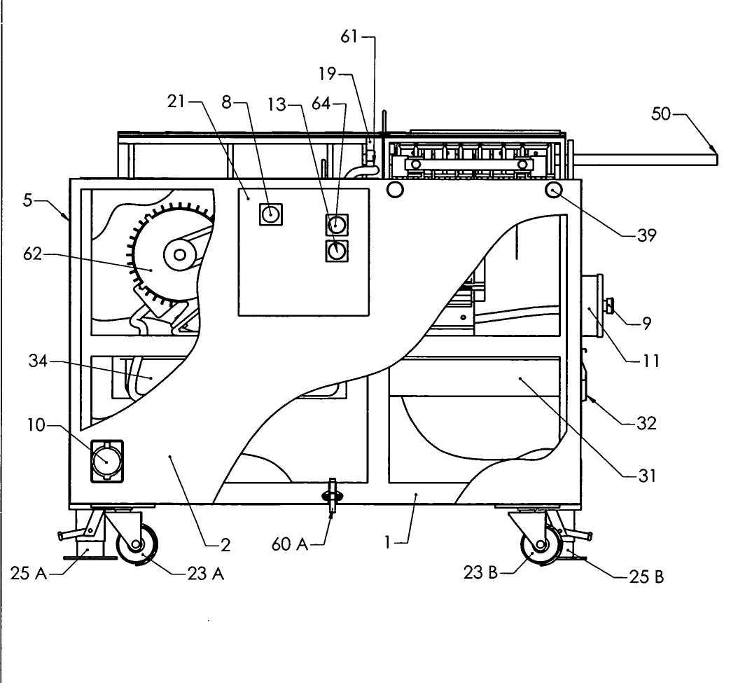

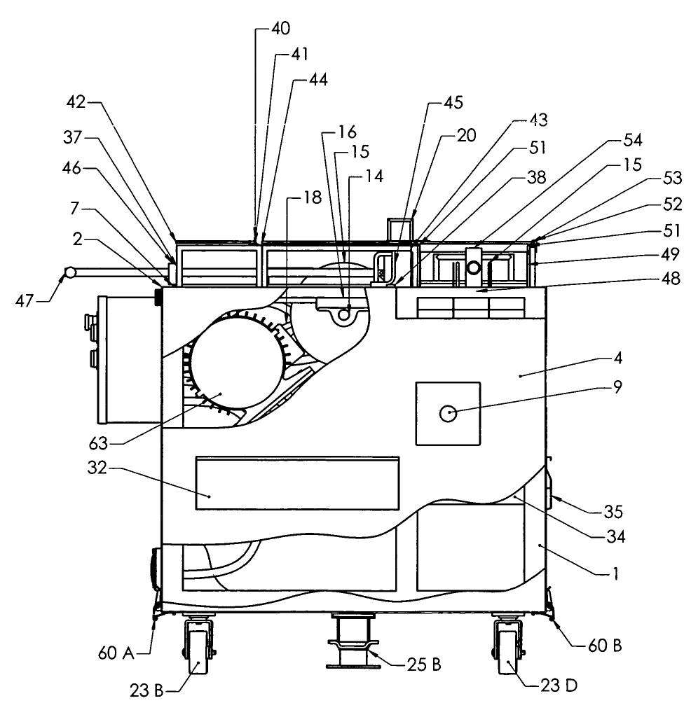

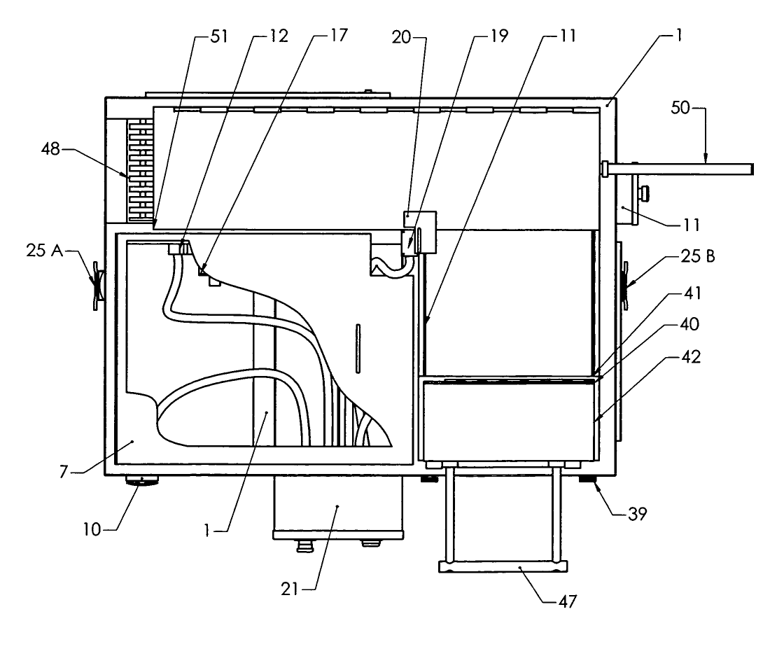

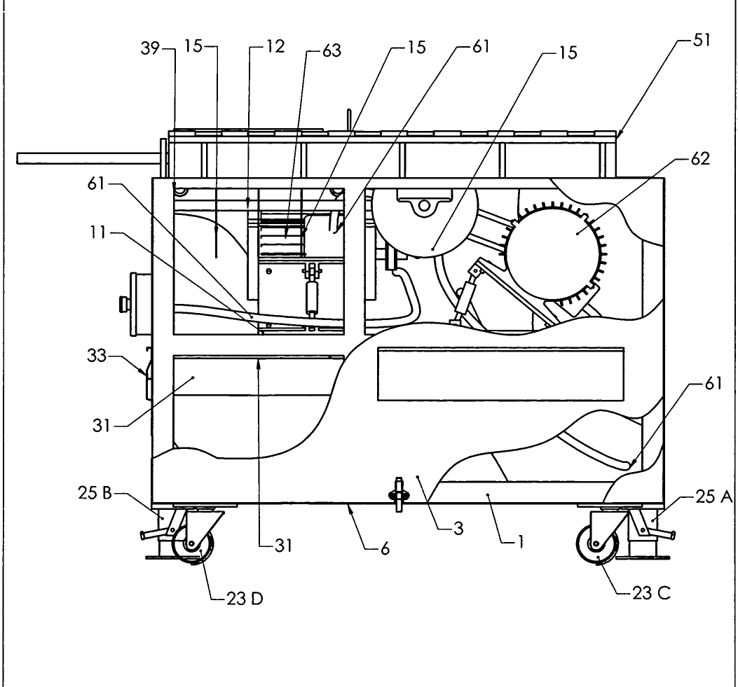

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This invention helps manufacturers of frozen or non frozen foods, and other manufacturers, who manufacture their product in a size that is economical for them to manufacture, but then find themselves needing to cut their product down in size to a size that the manufacturer feels will satisfy the needs of the consumer.

Other methods for cutting product, such as a band saw, have the problem of having to the operator push the product through the band by hand with the risk of catastrophic injury to the operators fingers and hands, which could increase worker compensation premiums, reduce production as the injured worker is on worker compensation and not at work, and reduce morale. Production is also slower than it could be, as the saw bands are thick. Production slows even more as the saw bands get dull. Production ceases altogether when the saw bands are being replaced. The manufacturer wastes product as the band saw is so thick, and wastes even more as it becomes dull, and wastes even more when pieces are deemed unsaleable due to their sides being too irregular. Plus, some of the product that is sold may look irregular and hence unappetizing, with a potential for no second sale to that customer.

On the other hand, the Espinosa Product Cutter, reduces or eliminates these problems, and gives the manufacturer the flexibility of making their product whatever size they deem ideal for the ultimate consumer, and increase product with no more work staff.

### BRIEF SUMMARY OF THE INVENTION

Food or any product of any width, that needs to be reduced in size to a set size, is fed into the Espinosa Product Cutter, the safety lid is closed which allows the engines to being, and the product is moved via push rods pushing a push bar until the produce crosses over the first set of saw blades, the number of which are limited only by the number of cuts that the manufacturer wants. The push bar is either controlled by push rods manually operated from outside the safely lid area, or by an automatic process. After going through the first set of blades, the now sliced product ends at the start of the second run. The first push blade is withdrawn, again, either by hand, or automatic process. When the first push blade is fully withdrawn, a second push blade, again operated manually by push rods from outside the safety lid area, or by an automatic process, push the product through a second set of saw blades, cutting each of the previously cut pieces in the opposite direction. The now reduced in size product is deposited at the end of the second run for removal, or depositing onto some other means of conveyance. The second push blade then is withdrawn, either by the bar, or automatic process, and when it is fully with drawn, more product can be loaded again.

At the end of the shift, the machine locks can be deactivated, the machine can be rolled over above a drain, the bottom of the machine opens up by dropping down, any waste that accumulates under either set of blades can be removed by taking out the drawers, the top comes up, and the entire thing can be sprayed clean with water, so that it is perfectly clean and ready to run at the next shift.

The Espinosa Product Cutter, reduces or eliminates the problems of the band saw: It reduces the risks of cuts or amputations as the product is pushed across the blades either by a pusher bar or by automatic process, under a safety lid, that kills the motors if it is open, the blades are made of a better grade surgical steel that is heat treated, beveled, and saw toothed, so it doesn't wear out so fast, there is more product for sale as the blades are thinner, there is less down time as the blades get replaced less frequently, and there are no irregular and unappetizing pieces as all of them end up the same size. Workers can produce more per shift that under the old way.

### BRIEF DESCRIPTION OF THE SEVERAL VIEWS OF THE DRAWING

Sheet 1 of 5 shows the Espinosa Product Cutter from the front side, the right side, and the top. One the front side you see the control box with the on off buttons, and the emergency kill button. To it's right are the push rods sticking out from under the safety lid. Also on this side you see the power hook up down on the lower left side, 2 wheels for rolling the device about, and one of the 2 floor locks for cleaning out the inside. On the right side you see the push bar extending beyond it's safety cage, the emergency kill switch, the clean out drawer, which collects from the first set of saw blades, more wheels, and a lock to keep the machine in place. On the top you see the safety cages for both saw runs, and a lid that lifts up to allow access to the inner motors, pulleys, and support bars for clean out, and repair if necessary.

Sheet 2 of 5 shows the Espinosa Product Cutter from the front side. Here you see the control box with the on off buttons, and the emergency kill button. To it's right are the push rods sticking out from under the safety lid. Also on this side you see the power hook up down on the lower left side, 2 wheels for rolling the device about, and one of the 2 floor locks for cleaning out the inside. You also see the push plate, with the corresponding slits in it so as to go past the saw blades. You also see the locks to hold the machine in place. You also see the motors that operate the saw blades, and the drawers that pull out.

Sheet 3 of 5 shows the Espinosa Product Cutter from the right side. Here you see the push bar extending beyond it's safety cage, the emergency kill switch, the clean out drawer, which collects from the first set of saw blades, more wheels, and a lock to keep the machine in place. You also see the push plate, with the corresponding slits in it so as to go past the saw blades. You also see one motor that operates saw blades, and the drawers that pull out.

Sheet 4 of 5 shows the Espinosa Product Cutter from the top side. At the bottom of the page is the front side, with the power outlet on the left, the control panel in the middle, and the push bars on the right. On the right side is the pull out drawer, the lock device, the kill switch, and the push bar. On the back side there is another drawer. And on the left side we see a lock wheel. On top of the drawing, on the lower left side is the part that opens up to allow access to the engines and blades and pulleys and on the lower right side is the first cutting run, and then across the top is the longer run. You can see the hinges that are attached to the safety lid.

Sheet 5 of 5 shows the Espinosa Product Cutter from the back side. Down at the bottom are 2 more wheels, and the second lock to allow the bottom to drop out for cleaning. On each side of the wheels we see the wheel locks. The kill switch is visible on the left side, as is the drawer below it. The drawer on the back side is visible below the engine inside the device. The engine that is visible moves the saw blades that are visible, making the second cut in the product pushed atop them via the pusher blade. All of the cutting occurs under a safety lid. The product, cut to it's final size, comes out on the upper right side of the device.

### DETAILED DESCRIPTION OF THE INVENTION

The machine is wheeled into it's desired place via wheels (23 A, B, of Sheet 2 of 5) and then locked into place (25 A, B of Sheet 2 of 5). The pusher bar (47 on Sheet 3 of 5) is fully extracted, and the product is inserted into the device (42 of Sheet 4 of 5) onto the slide (48 on Sheet 4 of 5). The safety lid is closed (40 of Sheet 4 of 5). Assuming both safety lids are closed, then the safety switch (20 of Sheet 2 of 5) allows the operator to start the motor by pressing on start button (64 of Sheet 2 of 5). Should there be a problem, then the machine is stopped by pressing the off button (13 of Sheet 2 of 5) or either of the two panic buttons (8 of Sheet 2 of 5, 9 of Sheet 3 of 5).

Electricity flows from the plug in (10 of Sheet 2 of 5) through cables in the control panel (21 of Sheet 2 of 5), through wire (61 of Sheet 5 of 6) to both motors, (62 of Sheet 2 of 5, 63 of Sheet 3 of 5), which start, powering, through fan belts (18 of Sheet 3 of 5) and pulleys, two sets of saw blades (15 of Sheet 3 of 5 and 4 of 5).

The product is then pushed over the first set of saw blades by the push bar and push plate (45 of Sheet 3 of 5), getting cut as it goes. When the product is fully cut, it ends up at the start of the second run, and the push bar and push plate are retracted.

The same process as set forth in 1018 occurs, using different blades, push bar, push plate, and saw blades, with the result that the product gets cut in the opposite direction, and gets pushed out of the machine, for either manual removal, or moving onto a conveyor belt.

After the shift is over, or if the company decides to cut something differently, the device is turned off, unplugged, the 2 wheel locks are undone, and the machine is wheeled over above a drain, and then it is cleaned. This is done by emptying out both drawers (31 on Sheet 2 of 5, and 32 on Sheet 3 of 5), opening up both sets of safety lids, opening up the door exposing the insides of the machine (7 of Sheet 4 of 5), opening up the door on the bottom (6 of Sheet 5 of 5) by unlocking them with the locking mechanism (60A of Sheet 2 of 5 and 60B), and then spraying water all around inside until it is perfectly clean.

The first and second runs can be made wider to accommodate larger pieces of product.

The first and second run can have more saw blades to cut the product into more pieces.

1. What I claim as my invention is a machine that
a: sits on wheels so it can be conveniently moved about, and when in it's desired position can be locked into place.
b. Is made of stainless steel so it does not harbor bacteria, so it can be used in the food industry, among others.
c. Is made with closed and sealed electrical wires, switches, and motors, so it can be washed down with water so it cleans easily and can be used in the food industry, among others.
d. Allows for the cutting of products, food or otherwise, with fingers and hands being kept away from the cutting blades with a reduced risk of catastrophic injury to finger/s and hand/s.
e. Allows for the cutting of all food products, frozen, hard, or soft.
f. Allows for the cutting of all other products, frozen, hard, or soft.
g. Allows for the movement of the machine over a drain where the bottom opens up, the drawers pull out, and the entire machine can be quickly, completely, and easily hosed clean.

2. A cutting machine in accordance with claim 1 that cuts the product by running it through 2 sets of saw blades, the number of which are limited to only how many pieces the product manufacturer wants.

3. A cutting machine in accordance with claim 1 that cuts product any width and any length, by running it through the first set of saw blades.

4. A cutting machine in accordance with claim 1 that cuts any product into as many pieces as the manufacturer of the product wants to be made going one way through the machine.

5. A cutting machine in accordance with claim 1 that cuts any product into as many pieces as the manufacturer of the product wants to be made by running it through the second set of saw blades.

6. A cutting machine in accordance with claim 1 that cuts any product into any sized piece that the product manufacturer wants the product to cut to.

7. A cutting machine in accordance with claim 1 that cuts any product into any sized piece that the product manufacturer wants the product to be cut to, with precision.

8. A cutting machine in accordance with claim 1 that gives better production over a longer time.

9. A cutting machine in accordance with claim 1 that gives higher work yield with no increase in labor costs.

10. A cutting machine in accordance with claim 1 that gives higher worker yeild with lower labor costs.

11. A cutting machine in accordance with claim 1 that gives more uniform size pieces, whatever the size may be.

12. A cutting machine in accordance with claim 1 that gives higher production than band saws gives.

13. A cutting machine in accordance with claim 1 that reduces the waste that occurs with the use of band saws.
